(19) United States
(12) Patent Application Publication
(10) Pub. No.: US 2021/0243188 A1
(43) Pub. Date: Aug. 5, 2021

(54) METHODS AND APPARATUS FOR AUTHENTICATING DEVICES

(71) Applicant: Arm IP Limited, Cambridge, Cambridgeshire (GB)

(72) Inventor: Thomas Christopher GROCUTT, Cambridge, Cambridgeshire (GB)

(21) Appl. No.: 17/053,922

(22) PCT Filed: May 8, 2019
(86) PCT No.: PCT/GB2019/051259

§ 371 Date: Nov. 9, 2020

(30) Foreign Application Priority Data
May 11, 2018 (GB) 1807652.1

(51) Int. Cl. H04L 29/06

(52) U.S. Cl. CPC H04L 63/0876; H04L 63/18; H04L 63/20; H04L 63/062

(57) ABSTRACT

A network management agent is provided to enable a secure connection to a network to be established. The network management agent confirms the identity of a device upon receipt of a device identifier from the device, via a first communication channel, and responds with a security token, via the first communication channel, which the device uses to confirm the identity of the network management agent. The network management agent is able to trust the device and the device is able to trust the network management agent, such that the device may be granted access to a network which it trusts. The network management agent may be provided, via a second communication channel, with a device identifier and a device security token for the device from which the security token to be transmitted over the first channel is derived.

The present techniques relate to authenticating the identity of a device. More particularly, the techniques relate to mutual authentication of a device and a network management agent.

More and more devices are being connected to networks, for example, as part of the Internet of Things (IoT). Relatively large IoT devices, such as mobile telephones, tablets and laptop computers, and relatively small devices, such as temperature sensors, healthcare monitors and electronic door locks, may all be connected to a network. Setting up new IoT devices when they want to join a network can be a painful process. This is especially true of devices that have a minimal user interface, where entering long WiFi™ passwords etc. can be tricky, slow, and non-intuitive.

According to a first technique, there is provided a method for a network management agent to establish trust of a device. The method comprising: receiving, at the network management agent from the device, via a first channel, a first device identifier; authenticating the device based upon the received first device identifier and a second device identifier of the device provided, via a second channel, to the network management agent to establishing at the network management agent, trust of the device; and transmitting, from the network management agent to the device, via the first channel, a security token; wherein the security token is derived from a device security token of the device provided, via the second channel, to the network management agent; and wherein the first channel is different from the second channel.

According to a second technique, there is provided a network management agent for establishing trust with a device. The network management agent comprising: a communications module for receiving, via a first channel, a first device identifier of the device; a storage module for storing a second device identifier of the device and a device security token of the device provided, via a second channel, to the network management agent; and a processing module for authenticating the device based upon the received first device identifier of the device and the stored second device identifier of the device and establishing trust of the device, the processing module further for instructing the communications module to transmit to the device, via the first channel, a security token derived from the device security token of the device; wherein the first channel is different from the second channel.

According to a third technique, there is provided a method for a device to establish trust of a network management agent. The method comprising:

transmitting, from the device to the network management agent, via a first channel, a device identifier of the device; receiving, at the device from the network management agent, via the first channel, a security token, the security token derived from a device security token of the device received at the network management agent via a second channel; authenticating the network management agent based upon the received security token and another device security token of the device stored at the device; and in response to authenticating the network management agent, establishing at the device, trust of the network management agent; wherein the first channel is different from the second channel.

According to a fourth technique, there is provided a method for a device to establish trust of a network management agent. The method comprising: transmitting, from the device to a network management agent of a network, via a first channel, a device identifier of the device; receiving, at the device from the network management agent, via the first channel, a not authenticated error response; identifying a further network; transmitting, from the device to a network management agent of the further network, via a first channel, a device identifier of the device; receiving, at the device from the network management agent of the further network, via the first channel, a security token, the security token derived from a device security token of the device received at the network management agent of the further network via a second channel; authenticating the network management agent of the further network based upon the received security token and another device security token of the device stored at the device; and in response to authenticating the network management agent of the further network, establishing at the device, trust of the network management agent of the further network; wherein the first channel is different from the second channel.

According to a fifth technique, there is provided a device for establishing trust with a network management agent, the device comprising: a storage module for storing a device identifier of the device and a device security token of the device; a communications module for transmitting to the network management agent, via a first channel, the device identifier, and for receiving from the network management agent, via the first channel, a security token, the security token derived from a device security token of the device received at the network management agent via a second channel; and a processing module for authenticating the network management agent based upon the received security token and the device security token of the device stored at the device, and establishing at the device, trust of the network management agent; wherein the first channel is different from the second channel.

According to a sixth technique, there is provided a method for a network management agent to establish trust of a device. The method comprising: receiving, at the network management agent, via a second channel, a second device identifier of the device and a device security token of the device; transmitting, from the network management agent to a network access device, the second device identifier; receiving, at the network access device from the device, via a first channel, a first device identifier of the device; authenticating, at the network access device, the device based upon the received first device identifier of the device and the second device identifier of the device; in response to authenticating the device, establishing at the network access device, trust in the device; and transmitting, from the network management agent to the device, via the first channel, a security token derived from the device security token of the device; wherein the first channel is different from the second channel.

According to a seventh technique, there is provided a computer readable storage medium comprising program code for performing the methods described herein.

Embodiments will now be described with reference to the accompanying figures of which:

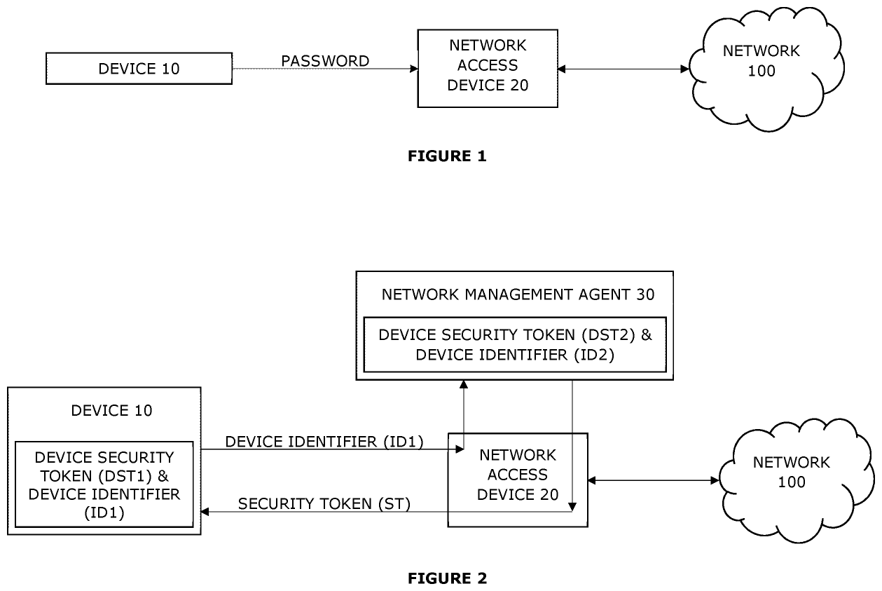

FIG. 1 schematically illustrates a system for a device to access a network;

FIG. 2 schematically illustrates a system for authenticating a device;

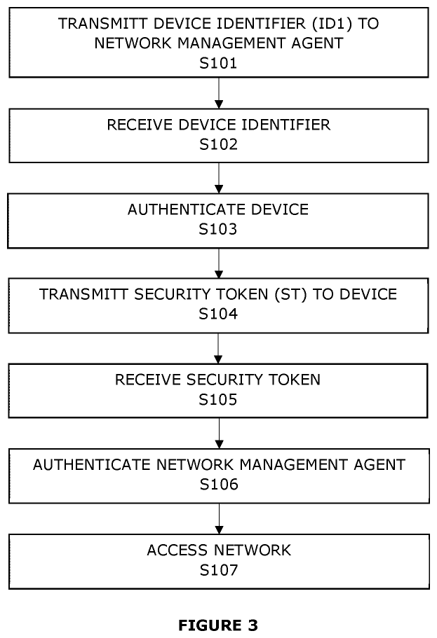

FIG. 3 illustrates a process flow of a method for a device to establish trust of a network management agent and for a network management agent to establish trust of a device;

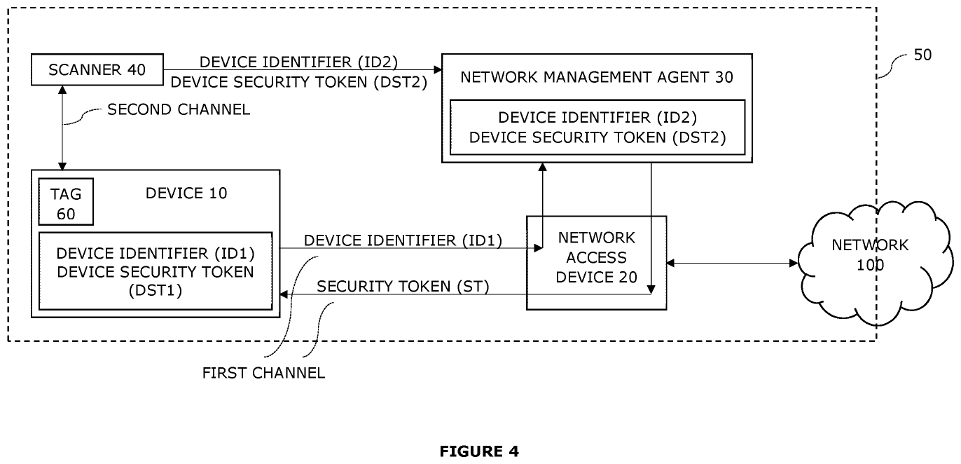

FIG. 4 schematically illustrates a system for authenticating a device;

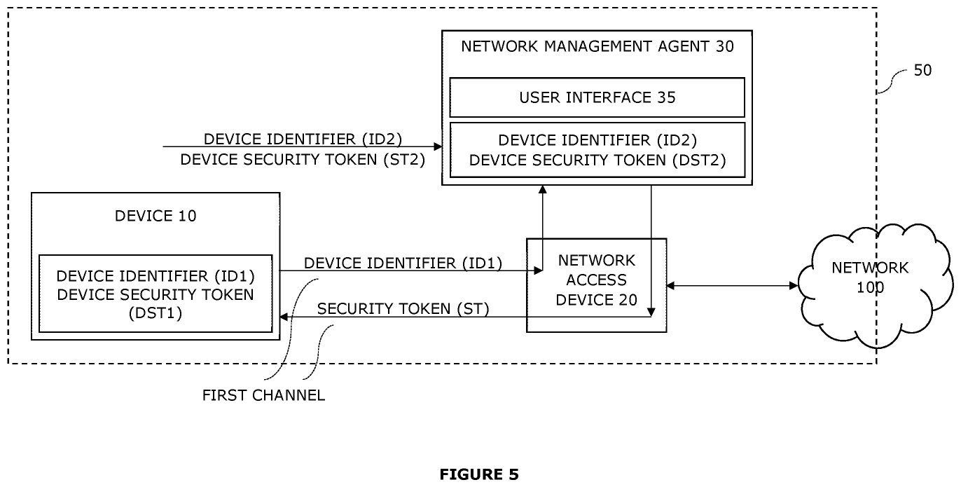

FIG. 5 schematically illustrates a system for authenticating a device;

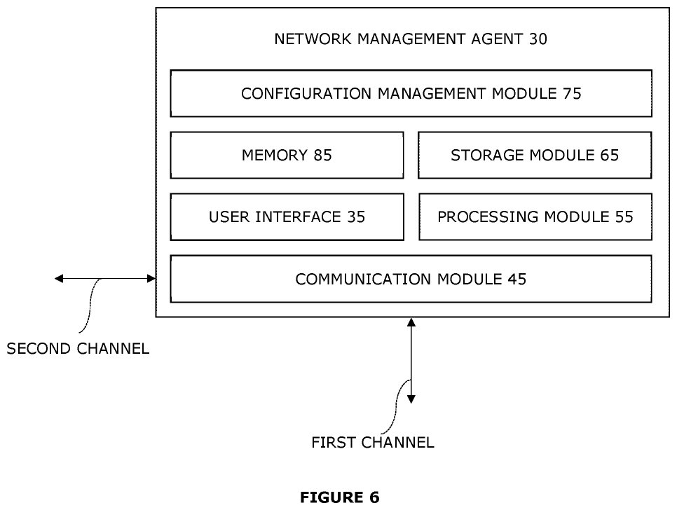

FIG. 6 schematically illustrates a network management agent for establishing trust with a device; and

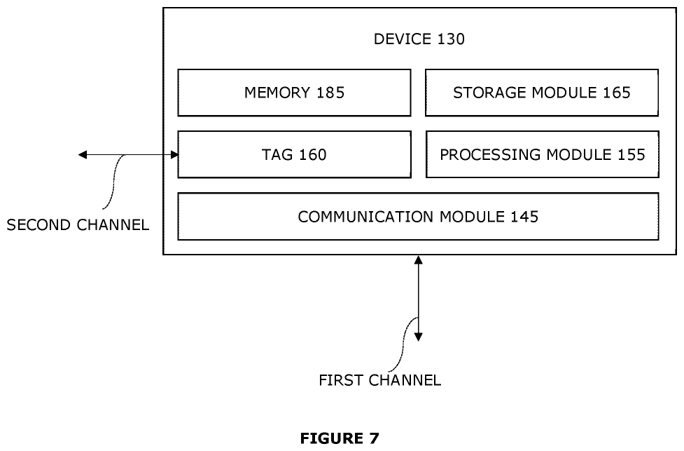

FIG. 7 illustrates schematically a device for establishing trust with a network management agent.

A network management agent is provided to enable a secure connection to a network to be established. The network management agent confirms the identity of a device upon receipt of a device identifier from the device, via a first communication channel, and responds with a security token, via the first communication channel, which the device uses to confirm the identity of the network management agent. The network management agent is able to trust the device and the device is able to trust the network management agent, such that the device may be granted access to a network which it trusts. The network management agent may be provided, via a second communication channel, with a device identifier and a device security token for the device from which the security token to be transmitted over the first channel is derived.

The network management agent may transmit the security token to the device, in response to receiving a request for the security token from the device, instead of transmitting the security token in response to receiving the device identifier.

Reference will now be made in detail to the embodiments, examples of which are illustrated in the accompanying figures. In the following detailed description numerous specific details are set forth by way of examples in order to provide a thorough understanding of the relevant teachings. However, it will be apparent to one of ordinary skill in the art that the present teachings may be practiced without these specific details.

In other instances, well known methods, procedures, components and/or circuitry have been described at a relatively high-level, without detail, in order to avoid unnecessarily obscuring aspects of the present teachings.

FIG. 1 schematically illustrates a system for a device to access a network. Device 10 requires access to a network 100. Access to the network 100 is facilitated by a network access device 20. The network access device 20 may be a WiFi™ router, Bluetooth™ gateway device, Zigbee™ network device etc. In order to be granted access to the network 100, the device 10 should be a trusted device. Conventionally, a user would be required to enter a password for the network access device 20 into the device 10, so that the network access device 20 may trust the device 10 and grant access to the network 100. Access to the password confirms that the user is allowed to access the network, by the owner of the network. However, entering a password into the device 10 may be tricky, slow, and non-intuitive for the user.

FIG. 2 schematically illustrates a system for authenticating a device. A network management agent 30 is provided, which may be used to determine whether the device 10 is a trusted device. When the device 10 is considered a trusted device, the network management agent 30 informs the network access device 20 that the device 10 may be granted access to the network 100. The network management agent 30 is provided with a device identifier ID2 for each device that it is to authenticate, prior to the device being granted access to the network 100.

The provision of a network management agent 30 does not preclude the use of conventional password authentication for devices where the network management agent 30 is not provided its device identifier ID2, and/or for devices such as laptops where entering a password is easy. For example, a network may use a network management agent 30 to authenticate some devices and a password to authenticate other devices.

The device identifier ID2 may be any identifier used to identify the device 10. The device identifier ID2 may comprise numbers, letters, or a combination of numbers and letter. Alternatively, the device identifier ID2 may be a raw binary value. For example, the device identifier ID2 may be a product number, serial number, MAC address etc. for the device. Preferably, the device identifier ID2 is globally unique, so that no two devices throughout the world share the same device identifier.

The network management agent 30 stores the device identifiers ID2 of the devices which are permitted to access to the network. The network management agent 30 may store the device identifiers ID2 in the form which they are provided to the network management agent 30. Alternatively, the network management agent 30 may store a version of the device identifier ID2 provided to the network management agent 30, which is derivable from or indicative of the device identifier

ID2, such as an encrypted version of the device identifier, a hash of the device identifier etc. In another embodiment, the network management agent 30 may store a value that can be used to derive the device identifier ID2, such as a value to be hashed to produce the device identifier ID2.

When a device 10 requires access to the network 100, it transmits its device identifier ID1 to the network management agent 30 via the network access device 20. According to one embodiment, the device 10 is not required to know of the existence of the network management agent 30 and transmits its device identifier to the network access device 20. The network access device 20 may then transmit the device identifier ID1 to the network management agent 30, querying whether the device is a permitted device. Alternatively, the network management agent 30 may provide a list of permitted devices to the network access device 20.

The device identifier ID1 may be any identifier used to identify the device 10. The device identifier ID1 may comprise numbers, letters, or a combination of numbers and letter. Alternatively, the device identifier ID1 may be a raw binary value. For example, the device identifier ID1 may be a product number, serial number, MAC address etc. for the device. Preferably, the device identifier ID1 is globally unique, so that no two devices throughout the world share the same device identifier. The device identifier ID1 transmitted by the device 10 to the network access device 20 may be the same as the device identifier ID2 provided to the network management agent 30 or may be different from the device identifier ID2 provided to the network management agent 30. However, both the device identifier ID1 and the device identifier ID2 are used to identify the device 10.

The device 10 may store its device identifier ID1, or may store a version of its device identifier ID1, which is derivable from or indicative of its device identifier ID1, such as an encrypted version of the device identifier ID1, a value to be hashed to produce the device identifier ID1 etc.

The identity of the device is confirmed based on the device identifier ID1 transmitted from the device 10 to the network access device 20, and the device identifier ID2 of the device 10 which has been provided to the network management agent 30. The network management agent 30 stores an indication of one or more devices which are authorised to access the network 100, for example as a list. According to one embodiment, it is determined whether the device identifier ID1 is related to the device identifier ID2, and when they are related, the identity of the device is confirmed. Determining whether the device identifier ID1 is related to the device identifier ID2 may comprise determining that the device identifier ID2 is an encrypted version of the device identifier ID1, determining that the device identifier ID2 is derivable from the device identifier ID1, determining that the device identifier ID1 and the device identifier ID2 are the same etc. Determining whether the device identifier ID1 and the device identifier ID2 are related may be ascertained in many different ways. According to one embodiment, the device identifier ID1 and the device identifier ID2 are both the WiFi™ MAC address, and the two device identifiers are determined to be related by performing a basic comparison. When it is determined that the device identifier ID1 is related to the device identifier ID2, then the identity of the device is confirmed.

As stated above, the network access device 20 may transmit the device identifier ID1 to the network management agent 30, in which case, the network management agent 30, determines whether the device identifier ID1 is related to the device identifier ID2 and informs the network access device 20 of the result. Alternatively, when the network management agent 30 provides a list of permitted devices to the network access device 20, then the network access device 20 determines whether the device identifier ID1 is related to the device identifier ID2.

The device 10 may transmit the device identifier ID1 to the network access device 20 using a first communication channel. The first communication channel may be a wireless local area network, such as WiFi™, Zigbee™, Bluetooth™ etc., or a cellular network, such as 3G, 4G, 5G etc. As known in the art, the network access device 20 grants limited access to the network, such that the device 10 may transmit the device identifier ID1 to the network access device 20. For example, the device identifier ID1 is sent to the network access device 20 as part of the initial negotiation for access to the network.

Following confirmation of the identity of the device 10 and that the device is authorised to access the network 100, the device 10 may be granted access to the network 100. However, this arrangement leaves the device 10 vulnerable to attacks. The network access device 20 has had it confirmed that the device is an authorised device, however, the device has not confirmed that the network to which it has gained access is in fact the network it intended to access. For example, two adjacent properties may each have their own network which are detectable from either property. The devices within each of the properties only desire to access the network of their property. Therefore, the devices within each of the properties require to confirm that the network it has been granted access to is the intended network.

In response to receiving the device identifier ID1 from the device, via the first communication channel, the network management agent 30 transmits a security token ST derived from a device security token DST2 of the device 10, to the device 10, via the first communication channel. The network management agent 30 is provided with a device security token DST2 for each device that it is to authorise to access the network 100. Each device security token DST2 is associated with a device identifier ID2 at the network management agent 30.

The network management agent 30 is provided with a device identifier ID2 and a device security token DST2 for each device 10, it is to authorise to access the network 100, via a second communication channel. The second communication channel being different from the first communication channel. The network management agent 30 is provided with a device identifier and associated security token for a device, prior to the device requiring access to the network 100. When a device attempts to access the network 100, prior to the network management agent 30 being provided with a device identifier and associated security token for that device, then the device will not be granted access by the network management agent 30.

The transmission of a device identifier ID1 from the device may be considered a challenge to the network management agent 30, to respond with a security token ST. According to one embodiment, sending the device identifier ID1 to the network management agent 30 acts as a request for a security token from the network management agent 30, triggering the network management agent 30 to send the security token ST. According to another embodiment, the device identifier ID1 may be sent to the network management agent 30 and a separate request for a security token may be sent to the network management agent 30.

The security token DST2 may be any security indicator that may be used to confirm that the network 100 that the device 10 is granted access to, is in fact the network 100 to which the device 10 wishes to connect. A network which is not a network to which the device wishes to connect, will not have been provisioned with the device security token DST2 from which the security token ST is derived. The device security token DST2 may comprise numbers, letters, a combination of numbers and letter, or a binary value. For example, the device security token DST2 may be a security object of the device 10, a random number, a secret, a key etc. Preferably, each device security token DST2 is globally unique, so that no two devices throughout the world share the same device security token DST2.

The network management agent 30 stores the device security token DST2 of the devices which are permitted to access the network 100. The device security token DST2 and the device identifier ID2 of the same device 10 are associated with each other. As with the device identifiers, the network management agent 30 may store the device security tokens DST2 in the form which they are provided to the network management agent 30. Alternatively, the network management agent 30 may store a version of the device security token DST2 provided to the network management agent 30, which is derivable from or indicative of the device security token DST2, such as an encrypted version of the device security token etc.

Following receipt of a device identifier ID1, and authentication of the device 10, the network management agent 30 transmit a security token ST, derived from the security token DST2 associated with the device identifier ID2 of the device 10, to the device 10 which transmitted the device identifier ID1, via the network access device 20. The security token ST is transmitted from the network management agent 30 to the device 10 over the first communication channel, the same channel as the device 10 transmitted the device identifier ID1 to the network management agent 30.

The security token ST is derived from the device security token DST2. The security token ST sent over the first channel may not be that same as the device security token DST2 received at network management agent 30 via the second channel. For example, the device security token DST2, received at the network management agent 30, may be hashed with the device identifier ID1, the device identifier ID2, or a nonce, to generate a security token ST which is transmitted over the first channel to the device. However, the security token ST derived from the device security token DST2 and sent over the first channel may be that same as the device security token DST2 received at network management agent 30 via the second channel.

The device 10 stores its own device security token DST1. The device security token DST1 may comprise numbers, letters, a combination of numbers and letter, or a binary value. For example, the device security token DST1 may be a security object of the device 10, a random number, a secret, a key etc. Preferably, each device security token DST1 is globally unique, so that no two devices throughout the world share the same device security token. The device 10 may store its device security token DST1, or may store a version of its device security token, which is derivable from or indicative of its device security token DST1, such as an encrypted version of the device security token etc. The device security token DST1 of the device 10 may be the same as the device security token DST2 of the device 10 which is provided to the network management agent 30. Alternatively, the device security token DST1 of the device 10 may be different from the device security token DST2 of the device 10 which is provided to the network management agent 30. For example, a private/public key pair may be used as the device security tokens DST1, DST2. The network management agent 30 stores the device security token DST2 (or an indication of the device security token DST2) for each device it is to authorise to access the network 100.

The identity of the network 100 to which the device requires access is confirmed based on the device security token DST1 stored at the device 10 and the security token ST transmitted from the network management agent 30 to the device 10. By virtue of the network management agent 30 transmitting the correct security token ST, the device confirms that it may trust the network, i.e. the device belongs to the network.

According to one embodiment, it is determined whether the security token ST is related to the device security token DST1, and when they are related, the identity of the network 100 is confirmed and trust established. For example, the security token ST may be an encrypted version of the device security token DST2 provided to the network management agent 30, and when decrypted at the device, is determined to be related to the device security token DST1 stored at the device. When the device security token DST1, the device security token DST2 and the security token ST are the same, and thus are related, then the security tokens may be compared, and when the tokens match, the identity of the network 100 is confirmed.

Following authentication of the network, the device 10 may access the network 100 via the network access device 20.

When a device identifier and/or device security token has not been provided to the network management agent 30, then the device will not be authenticated by the network management agent 30. For example, when the network management agent 30 does not have a device identifier ID2 corresponding to the device identifier ID1 transmitted by the device over the first channel, then the network management agent 30 will not authenticate the device and the device will not be allowed access to the network, unless another method of authentication is used, such as a password. Further, when the network management agent 30 does not respond with a security token/the correct security token (i.e. the security token transmitted to the device is determined not to relate to the device security token at the device), then the device disconnects from the network and performs a scan to identify another network to connect. Without receipt of a correct security token, the device does not trust the network 100 and therefore, although the device may have been granted access to the network, the device does not make use of the network.

FIG. 3 illustrates a process flow of a method for a device to establish trust of a network management agent and for a network management agent to establish trust of a device.

At step S101 a device identifier ID1 is transmitted, from the device to the network management agent. The device identifier ID1 is transmitted via a first communication channel. At step S102 the device identifier ID1 is received at the network management agent. At step S103, the device is authenticated at the network management agent. The device is authenticated based upon the received device identifier ID1 and a device identifier ID2 provided at the network management agent. The device identifier ID2 has been provided to the network management agent via a second communication channel. In response to authenticating the device, the network management agent establishes trust in the device.

At step S104 a security token ST, derived from a device security token DST2 of the device, is transmitted, from the network management agent to the device, via the first communication channel. The device security token DST2 of the device has been provided to the network management agent, via the second communication channel. At step S105 the security token ST is received at the device. At step S106, the network management agent is authenticated at the device. The network management agent is authenticated based upon the received security token ST and a device security token DST1 of the device stored at the device. In response to authenticating the network management agent, the device establishes trust in the network.

Finally, at step S107, the device accesses the network. Although FIG. 3 illustrates the device accessing the network at step S107, the device is granted access to the network following authentication of the device at the network management agent at step S103. However, at the point, although the network management agent trusts the device, the device may not trust the network management agent/the network. Therefore, the device may not access the network, although it has been granted access, until the device has authenticated the network management agent and thus established trust in the network.

The network management agent 30 and network access device 20 described above may be used to provide access to a network, to all devices 10 within a predetermined vicinity. For example, it may be desirable to grant access to a network to all devices provided within a predefined area, such as an office building.

FIG. 4 illustrates a network management agent 30 and network access device 20 provided within a predefined area, indicated by the dotted line 50, for example, a building, such as an office building, home, or warehouse etc. The dotted line 50 indicates the perimeter of the building. A scanner 40 is also provided. The scanner may be an NFC tag scanner, barcode scanner, QR code scanner etc. One or more scanners 40 may be provided at the entrance(s) to the area 50. When a device 10 enters the building 50, the device is scanned. According to one embodiment, the device 10 is provided with a tag 60, and it is the tag 60 which is scanned by the scanner 40. The tag 60 may be a NFC tag, QR code, bar code etc. According to this embodiment, the link between the tag 60 and the scanner 40 forms the second channel, which may be optical in the case of a QR code or barcode, or may be a wireless channel in the case of an NFC tag. The device identifier ID2 and associated device security token DST2 of the device 10 may be encoded in the tag 60, such that when the tag 60 is scanned, the device identifier ID2 and device security token DST2 of the device 10 are read. The scanner 40 transfers the device identifier ID2 and device security token DST2 of the device 10 to the network management agent 30. Consequently, the network management agent 30 is provided with the device identifier ID2 and device security token DST2 of each device 10 which is within the area 50. According to some embodiments, the scanner 40 may connect to the network management agent 30 via the network access device 20. For example, the scanner 40 may use WiFi™ and the network access device 20 may be a WiFi™ access point. However, it will be appreciated that the device identifier ID2 and device security token DST2 travels over a second channel between the tag 60 and the scanner 40 in order to get to the network management agent 30.

Although the area 50 is described as a building, area 50 is not limited to being a physical building having walls, and area 50 may in fact define the perimeter of a site which may or may not comprise one or more buildings. In addition, the area 50 may comprise more than one network management agent 30 and more than one network access device 20 providing access to the network 100. Alternatively, there may be a single central network management agent 30 that manages access to the network 100 through multiple network access devices 20.

Furthermore, although a tag 60 is illustrated in FIG. 4, the tag 60 may be built into the device 10/may be a component of the device 10, such as an NFC tag, or may be provided on the outside of a device or on the device packaging, such as a QR code or bar code.

As stated above, each device that enters the area 50 is scanned by the scanner 40 using a second channel, and the scanned device identifier ID2 and device security token DST2 are transferred to the network management agent 30. When a device 20 which is within the area 50 requires access to the network 100, the device transfers its device identifier ID1 to the network management agent 30 via the first channel. The first channel being a different communication channel from the second channel.

Since the network management agent 30 has been provided with the device identifier ID2, when the device was scanned upon entry to the area 50, the network management agent 30 is able to verify the identity of the device as being a device within the area 50. The network management agent 30 transmits a security token ST derived from a device security token DST2 of the device, to the device. The device security token DST2 of the device was provided to the network management agent 30 when the device was scanned upon entry to the area 50 and associated with the device identifier ID2. The device is then able to confirm that the network management agent 30 is the network management agent 30 of the network 100. The network 100 being the network 100 of the area 50 the device is within, and thus the device is able to establish trust of the network 100. This system enables a device to establish a connection to a network securely without a user of the device being required to input complex security passcodes. The network 100 may comprise devices and resources both inside and outside the area 50, for example the network may provide access to the internet, and other IoT devices in the area 50.

The device identifier ID2 and the device security token DST2 of the device are provided to the network management agent 30 via the second channel. The above description refers to a scanner 40 providing the device identifier ID2 and the device security token DST2 to the network management agent 30. However, other techniques could be used to provide the network management agent 30 with the device identifier ID2 and the device security token DST2 of the device. For example, a user may purchase a device from a retailer. The retailer may then transfer the device identifier ID2 and device security token DST2 of the purchased device to the network management agent 30 which is associated with the user who purchased the device, or a network management agent 30 identified by the user who purchased the device. According to one embodiment, the communications channel between the retailer and the network management agent 30 forms the second communications channel, which may be the internet (ADSL VDSL, DOCSIS etc.), and, in the case of the area 50 being a domestic house, the communications channel between the device and the network management agent 30 forms the first communications channel, which may be WiFi™. According to another embodiment, the retailer may scan the devices tag, and then transmit the device identifier ID2 and device security token DST2 of the purchased device to the network management agent 30. When the purchased device is activated, within communication range of the network management agent 30, for example, when the device is turned on within area 50, then the device attempts to connect to the network 100 by providing its device identifier ID1 to the network management agent 30, and the network management agent 30 responds with a security token ST derived from the device security token DST2 of the purchased device.

Although the network management agent 30 and the network access device 20 are described as separate components, the network management agent 30 and the network access device 20 may be provided as a single device performing the functions of the network management agent 30 and the network access device 20.

As well as providing secure access to a network 100, the network management agent 30 may also provide a user interface 35 which enables a user to configure the device 10. The user interface 35 may be a web page, mobile telephone application, physical interface etc.

According to one embodiment, the user interface may allow a user to configure the level of access granted to each device 10 within area 50. When a device has been authenticated at the network management agent 30, then the user interface 35 may request a proprietor/administrator of the network 100 to confirm the grant of access to the newly authenticated device, rather than automatically granting access following successful authentication. According to one embodiment, a consent box may appear at the user interface 35 requesting a proprietor/administrator of the network 100 to consent. In addition, or alternatively, the proprietor/administrator of the network 100 may be required to indicate a level of granted access. For example, upon successful authentication of a device, the device may be granted a basic level of access to the network, such as access to the internet. The device is likely to need at least limited access to the network for it to receive the security token from the network management agent 30. However, the proprietor/administrator of the network 100 may grant the device additional access rights via the user interface 35, if desired. Further configuration parameters may also be set via the user interface 35, such as the duration of the access to the network, the duration of the increased access rights etc.

In addition, to the device identifier ID2 and the device security token DST2 of the device 10 being provided to the network management agent 30, further data regarding the device may also be provided to the network management agent 30. This further data may be provided together with the device identifier ID2 and the device security token DST2, via the second channel, or may be provided to the network management agent 30 via the first channel. The network management agent 30 may request further device data. Alternatively, the device may transmit the further device data to the network management agent 30, in response to trust in the network management agent 30 being established at the device 10. Such further data may include the type of device, make of device, features of the devices, configuration information the device requires, etc. This further data may be stored at the network management agent 30. An icon of the device may be one type of further data provided to the network management agent 30, such that following authentication of the device 10, the provided icon is displayed at the user interface 35, enabling a user to easily identify the device they wish to configure/is being asked to configure.

Device configurations for the device may be set by way of the user interface 35 of the network management agent 30, the user interface 35 enabling a user to define the device configurations. The device configurations may be transmitted, from the network management agent to the device, via the first channel. The device may then function in accordance with the device configurations. For example, the device configurations may define when the device is to be automatically turned on/off.

The further data provided to the network management agent 30 may be used to define the configuration parameters. For example, when the device is a smart phone, and further data has been provided to the network management agent 30 defining details of the smart phone, then the configuration parameters, are likely to be different from the configuration parameters when the device is a weather sensor etc.

For example, the device may be a smart lightbulb which has been purchased by a user, and the device identifier and device security token of the lightbulb provided to the network management agent 30. Upon activation of the lightbulb in the property 50, the lightbulb is authorised by the network management agent 30 and connected to the network 100 of the property. Further device data regarding the lightbulb may have been provided to the network management agent 30, such as the type of light bulb, its power rating, range of available output colours etc. The user interface 35, such as a web page, may then enable a user to configure parameters (device configurations) for the lightbulb. The user may define device configurations such as, the level of access to the network 100 granted to the lightbulb (a lightbulb is unlikely to need an high level of access to the network), which room the lightbulb is located in, automatic on/off times for the lightbulb, a brightness level for the lightbulb, an output colour of the lightbulb etc.

Device configurations may be defined for each device, via the user interface, and transmitted from the network management agent to the device. In addition, device configurations may be defined for all devices of the same type, via the user interface, and these device configurations may be transmitted, from the network management agent 30 to each device of the same type, upon activation of the device. Further device configurations may be set, for example, linking the device to other devices within the room/property etc. Referring to the previous example, the lightbulb may be linked to a TV, such that when the TV is turned on in the room, the lights are dimmed, or the lightbulb may be linked to a light switch for the room etc. The linking may be based on user input, for example, an user may indicate that a light switch is provided in the kitchen, and it will be linked to the lightbulbs in that room. Alternatively, the linking may be automatic, for example, when a smart smoke alarm is added to the network, the network management agent 30 may automatically link to all the other smart smoke alarms of the properties network so that all the smoke alarms go off at the same time. Such automatic linking may occur when no additional information (further device configurations) are required. It is clear to a skilled person that different devices may require different device configurations to be displayed at the user interface 35.

The device configurations transmitted from the network management agent 30 to each device may be considered to be high level configuration information, which is more than the basic data provided by a server on a network informing the device how to connect to and use the network. The device configurations vary in dependence on the device being connected to the network, however below is a non-exhaustive list of exemplary device configurations:
login details for a cloud service the device is to be connected to;
the name of the room into which the device is to be placed;
the type of room into which the device is to be placed (i.e. a bedroom, rather than “ben's bedroom”);
the location of the device on the earth (e.g. latitude/longitude/elevation);
configuration data for a home automation system the device is to communicate with;
details of the people using/living in the building (e.g. name, gender, weight);
authentication information of the people that are allowed to access the device (e.g. fingerprints/voice prints of the people);
details of the devices used by people in the building (e.g. user x has smartphone y);
device performance configurations (e.g. setting a brightness level for a light bulb, setting a temperature for a smart radiator to produce, setting a hydration level for a smart plant watering system etc.)
times/dates the devices should/should not be active (e.g. setting a washing machine to be active at night because the electricity is cheaper, or setting a washing machine not to be active at night because it's too noisy etc.)
restrictions on the usage of the internet connection (e.g. setting a smart tv to stream netflix™ at the highest possible quality, setting a smart tv to stream netflix™ at a restricted quality if the ISP limits data usage);

details of the electricity provider, and the electricity provider account the device is powered from. The user may have configured the room, using the user interface 35, prior to activation of the lightbulb, such that when the lightbulb is added to the room, and an indication given that the device is a lightbulb, the previously defined configuration parameters for a lightbulb within the specified room are transferred from the network management agent 30 to the newly authenticated lightbulb. Consequently, whenever a lightbulb is added to the room, such as a replacement for a blown bulb, each bulb does not need to be individually configured.

Alternatively, the user interface could be utilised to indicate when a device which has been detected by the network management agent 30, is not the users, for example, when a lightbulb is detected, which is in fact located in a neighbouring property, the user interface may be used to indicate that this is not the proprietors lightbulb and therefore should not be granted access to the network.

According to another embodiment, the user may activate the user interface 35 in order to define/adjust device configurations of a device, following activation of a device, rather than the user interface 35 being initiated upon activation of the device.

FIG. 6 illustrates schematically a network management agent 30. The network management agent 30 comprises a communications module 45 for receiving, at least, the device identifiers and security tokens and for, at least, receiving device identifiers and transmitting security tokens. The communication module 45 may be one interface which carries both the first and second channels (which later split), for example where a scanner 40 is connected to the network management agent 30 via WiFi™, or where the network management agent 30 is connected to both the network access device 20 and the scanner 40 via a wired network connection. Alternatively, the communication module 45 may be two distinct communication interfaces, for example when a retailer supplies the device identifier ID2 and the device security token DST2 to the network management agent 30, the first communication interface being WiFi™ and the second communication interface being the internet connection. The communications module 45 may use wireless communication such as WiFi™, Zigbee™, Bluetooth™, 6LoWPAN etc., short range communication such as radio frequency communication (RFID) or near field communication (NFC), or a cellular network, such as 3G, 4G, 5G.

The user interface 35 may be a web page, mobile telephone application, or a physical interface, such as a conventional computer screen, keyboard, and mouse. The user interface 35 may transmit received data to the configuration management module 75 for managing the configuration parameters for each device provided within the area 50.

The network management agent 30 also comprises a storage module 65 configured to store the device identifiers and security tokens. Storage module 65 may be coupled to the communications module 45 to, for example, receive and transmit data. The storage module 65 may be configured to communicate with the at least one processing module 55.

Memory 85 may store computer program code to implement the methods described herein. The processing module 55 may comprise processing logic to process data (e.g. programs, instructions received from a user, etc.) and generate output signals in response to the processing, such as performing the authentication of the received device identifiers. The processing module 55 is configured to communicate with the storage module 65, memory 85, configuration management module 75, user interface 35 and the communication module 45.

The memory 85 and/or the storage module 65 may comprise a volatile memory such as random access memory (RAM), for use as temporary memory whilst the network management agent 30 is operational. Additionally, or alternatively, the memory 85 and/or the storage module 65 may comprise non-volatile memory such as Flash, read only memory (ROM) or electrically erasable programmable ROM (EEPROM), for storing data, programs, or instructions received or processed by the network management agent 30.

FIG. 7 illustrates schematically a device 130 for establishing trust with a network management agent 30. The device 130 comprises a communications module 145 for transmitting, at least, a device identifier ID1 to the network management agent, and for receiving, at least, a security token ST from the network management agent, via the first channel. The communication module 145 may use wireless communication such as WiFi™, Zigbee™, Bluetooth™, 6LoWPAN etc., short range communication such as radio frequency communication (RFID) or near field communication (NFC), or a cellular network, such as 3G, 4G, 5G.

The device 130 also comprises a storage module 165 configured to store the device identifier ID1 of the device and device security token DST1 of the device. Storage module 165 may be coupled to the communications module 145 to, for example, receive and transmit data. The storage module 165 may be configured to communicate with the at least one processing module 155.

Memory 185 may store computer program code to implement the methods described herein. The processing module 155 may comprise processing logic to process data (e.g. programs, instructions received from a user, etc.) and generate output signals in response to the processing, such as performing the authentication of the network management agent based upon the received security token. The processing module 155 is configured to communicate with the storage module 165, memory 185, and the communication module 145.

The memory 185 and/or the storage module 165 may comprise a volatile memory such as random access memory (RAM), for use as temporary memory whilst the device 130 is operational. Additionally, or alternatively, the memory 185 and/or the storage module 165 may comprise non-volatile memory such as Flash, read only memory (ROM) or electrically erasable programmable ROM (EEPROM), for storing data, programs, or instructions received or processed by the device 130. The device 130 may also comprise a tag 160 encoded with a device identifier ID2 of the device and a device security token DST2 of the device, which may be scanned and transmitted via the second channel. Alternatively, in some embodiments the tag 160 may be on the outside of the device or on the packaging for the device.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

As will be appreciated from the foregoing specification, techniques are described providing a method for a network management agent to establish trust of a device.

According to techniques, the method further comprises: in response to authenticating the device, granting the device access to a network.

According to techniques, the method further comprises: determining that the first device identifier corresponds to the second device identifier.

According to techniques, the method further comprises: storing the second device identifier of the device and the device security token of the device at the network management agent.

According to techniques, the method further comprises: receiving, at the network management agent from the device, via the first channel, a request for the security token; and transmitting, from the network management agent to the device, via the first channel, the security token derived from the device security token of the device, in response to the request.

According to techniques, the method further comprises: scanning using a scanner device, a tag of the device to obtain, via the second channel, the second device identifier of the device and the device security token of the device encoded in the tag; and receiving, at the network management agent from the scanner device the second device identifier of the device and the device security token of the device.

According to techniques, the scanner device is provided at a physical entrance to an area supported by the network management agent, and the method further comprises: scanning the tag of the device upon entry to the area.

According to techniques, the method further comprises: receiving, at the network management agent from a device retailer the second device identifier of the device and the device security token of the device.

According to techniques, the method further comprises: enabling the device to authenticate the network management agent based upon the security token transmitted from the network management agent to the device and another device security token of the device stored at the device; and in response to the device authenticating the network management agent, enabling the device to establish trust of the network management agent.

According to techniques, authenticating the network management agent comprises: determining that the security token transmitted from the network management agent corresponds to the another device security token stored at the device.

According to techniques, the method further comprises: in response to authenticating the device, requesting an administrator of the network management agent consent to the device being granted additional access to the network; and in response to the consent, granting the device additional access to the network.

According to techniques, the method further comprises: transmitting, from the network management agent to the device, via the first channel, a request for further device data.

According to techniques, the method further comprises: receiving, at the network management agent, via the second channel, further device data.

According to techniques, the method further comprises: receiving, at the network management agent, via the first channel, further device data.

According to techniques, the method further comprises: storing the further device data at the network management agent.

According to techniques, the method further comprises: transmitting, from the network management agent to the device, via the first channel, device configurations for the device.

According to techniques, the method further comprises: providing a user interface enabling a user to define the device configurations for the device at the network management agent.

According to techniques, the user interface further enables a user to define device configurations for a type of device at the network management agent, and the method further comprises: receiving at the network management agent an indication of the type of device; and transmitting, from the network management agent to the device, via the first channel, the device configurations for the type of device.

According to techniques, the method further comprises: the network management agent linking the device to one or more other devices within the network; determining at the network management agent device configurations for the device in response to the device links; and transmitting, from the network management agent to the device, via the first channel, the device configurations for the device.

Techniques are also described providing a method for a device to establish trust of a network management agent.

According to techniques, transmitting the device identifier to the network management agent enables the network management agent to authenticate the device and grant the device access to a network.

According to techniques, authenticating the network management agent comprises: determining that the received security token corresponds to the another device security token of the device stored at the device.

According to techniques, the method further comprises: transmitting, from the device to the network management agent, via the first channel, a request for the security token.

According to techniques, the method further comprises: receiving a request for further device data from the network management agent.

According to techniques, the method further comprises: in response to authenticating the network management agent, transmitting, from the device to the network management agent, via the first channel, further device data.

According to techniques, the method further comprises: scanning, using a scanner device, a tag of the device, to obtain, via the second channel, the device identifier of the device and the device security token of the device encoded in the tag; and transmitting the device identifier of the device and the device security token of the device from the scanner to the network management agent.

According to techniques, the method further comprises: scanning the tag of the device upon entry to an area supported by the network management agent.

Techniques are also described providing a method for a device to establish trust of a network management agent.

According to techniques, transmitting the device identifier to the network management agent of the network enables the network management agent of the network to determine that the device is not authenticated and to transmit a not authenticated error response; and wherein transmitting the device identifier to the network management agent of the further network enables the network management agent of the further network to authenticate the device and grant the device access to the further network.

According to techniques, authenticating the network management agent of the further network comprises: determining that the received security token corresponds to the another device security token of the device stored at the device.

According to techniques, the method further comprises: transmitting, from the device to the network management agent of the further network, via the first channel, a request for the security token.

According to techniques, the method further comprises: receiving a request for further device data from the network management agent of the further network.

According to techniques, the method further comprises: in response to authenticating the network management agent of the further network, transmitting, from the device to the network management agent of the further network, via the first channel, further device data.

According to techniques, the method further comprises: scanning, using a scanner device, a tag of the device, to obtain, via the second channel, the device identifier of the device and the device security token of the device encoded in the tag; and transmitting the device identifier of the device and the device security token of the device from the scanner to the network management agent of the further network.

According to techniques, the method further comprises: scanning the tag of the device upon entry to an area supported by the network management agent of the further network.

Techniques are also described providing a device for establishing trust with a network management agent.

According to techniques, the device further comprises: a tag encoded with the device identifier of the device and the device security token of the device.

1. A method for a network management agent to establish trust of a device, the method comprising:
receiving, at the network management agent from the device, via a first channel, a first device identifier;
authenticating the device based upon the received first device identifier and a second device identifier of the device provided, via a second channel, to the network management agent to establishing at the network management agent, trust of the device; and
transmitting, from the network management agent to the device, via the first channel, a security token;
wherein the security token is derived from a device security token of the device provided, via the second channel, to the network management agent; and
wherein the first channel is different from the second channel.

2. The method of claim 1, further comprising:
in response to authenticating the device, granting the device access to a network.

3. The method of claim 1, wherein authenticating the device comprises:
determining that the first device identifier corresponds to the second device identifier.

4. The method of claim 1, further comprising:
storing the second device identifier of the device and the device security token of the device at the network management agent.

5. The method of claim 1, further comprising:
receiving, at the network management agent from the device, via the first channel, a request for the security token; and
transmitting, from the network management agent to the device, via the first channel, the security token derived from the device security token of the device, in response to the request.

6. The method of claim 1, further comprising:
scanning using a scanner device, a tag of the device to obtain, via the second channel, the second device identifier of the device and the device security token of the device encoded in the tag; and
receiving, at the network management agent from the scanner device the second device identifier of the device and the device security token of the device.

7. The method of claim 6, wherein the scanner device is provided at a physical entrance to an area supported by the network management agent, the method further comprising:
scanning the tag of the device upon entry to the area.

8. The method of claim 1, further comprising:
receiving, at the network management agent from a device retailer the second device identifier of the device and the device security token of the device.

9. The method of claim 1, further comprising:
enabling the device to authenticate the network management agent based upon the security token transmitted from the network management agent to the device and another device security token of the device stored at the device; and
in response to the device authenticating the network management agent, enabling the device to establish trust of the network management agent.

10. The method of claim 9, wherein authenticating the network management agent comprises:
determining that the security token transmitted from the network management agent corresponds to the another device security token stored at the device.

11. (canceled)

12. The method of claim 1, further comprising:
transmitting, from the network management agent to the device, via the first channel, a request for further device data.

13. The method of claim 1, further comprising:
receiving, at the network management agent, via the second channel, further device data.

14. The method of claim 1, further comprising:
receiving, at the network management agent, via the first channel, further device data.

15. The method of claim 1, further comprising:
receiving, at the network management agent, further device data, and storing the further device data at the network management agent.

16. The method of claim 1, further comprising:
transmitting, from the network management agent to the device, via the first channel, device configurations for the device.

17. The method of claim 16, further comprising:
providing a user interface enabling a user to define the device configurations for the device at the network management agent.

18. The method of claim 17, wherein the user interface further enables a user to define device configurations for a type of device at the network management agent, the method further comprising:
receiving at the network management agent an indication of the type of device; and
transmitting, from the network management agent to the device, via the first channel, the device configurations for the type of device.

19. The method of claim 1, further comprising:
the network management agent linking the device to one or more other devices within the network;
determining at the network management agent device configurations for the device in response to the device links; and
transmitting, from the network management agent to the device, via the first channel, the device configurations for the device.

20. A network management agent for establishing trust with a device, the network management agent comprising:
a communications module for receiving, via a first channel, a first device identifier of the device;
a storage module for storing a second device identifier of the device and a device security token of the device provided, via a second channel, to the network management agent; and
a processing module for authenticating the device based upon the received first device identifier of the device and the stored second device identifier of the device and establishing trust of the device, the processing module further for instructing the communications module to transmit to the device, via the first channel, a security token derived from the device security token of the device;
wherein the first channel is different from the second channel.

21-33. (canceled)

34. A computer readable storage medium comprising program code for performing the method of claim 1.
